(19) United States
(12) Patent Application Publication
(10) Pub. No.: US 2025/0311018 A1
(43) Pub. Date: Oct. 2, 2025

(54) UNTRUSTED 3GPP ACCESS

(71) Applicant: Telefonaktiebolaget LM Ericsson (publ), Stockholm (SE)

(72) Inventors: Jens POSCHER, Aachen (DE); Ralph DETKE, Herzogenrath (DE); Pedro TERCERO, Madrid (ES); Stefan EICHINGER, Pulheim (DE)

(21) Appl. No.: 18/863,166

(22) PCT Filed: May 6, 2022
(86) PCT No.: PCT/EP2022/062308

§ 371 Date: Nov. 5, 2024

(51) Int. Cl. H04W 76/10; H04L 61/4511; H04W 8/26; H04W 60/04

(52) U.S. Cl. CPC H04W 76/10; H04L 61/4511; H04W 8/26; H04W 60/04

(57) ABSTRACT

A method for operating a user equipment operating in a visited cellular network for which no roaming agreement exists between a home cellular network of the user equipment and the visited cellular network. The user equipment transmits an access request to the visited cellular network requesting access to the visited cellular network. The access request includes an identifier indicating to originate from a user equipment for which no roaming agreement exists with the home cellular network of the user equipment. The user equipment transmits a session establishment request to the visited network to establish a data packet session in the visited cellular network. The UE determines an address of a gateway providing access to the home cellular network, and establishes a connection to the gateway based on the determined address via the visited cellular network.

### TECHNICAL FIELD

The present application relates to a method for operating a user equipment, an access management entity, and a session management entity. Furthermore a method for operating a gateway is provided. In addition, the corresponding entities operating in the methods above are provided, a system comprising at least two of the entities, a computer program comprising program code and finally a carrier comprising the computer program.

### BACKGROUND

For mission critical network users, including emergency service teams, public safety officers, humanitarian forces and peacekeeping delegations, it is critical to be always and anywhere connected to the Internet.

For mobile networks, 3GPP defines the roaming architecture, where subscribers in visited networks are home-routed to the home network for the services of the own network operator. Authentication and authorization play a major role and depending on the 3GPP network release it is done in the home network and/or visited network. The visited and home network need to be configured and deployed with this architecture, and between the operators Service Level Agreements (SLAs) need to be defined.

If a subscriber moves in an area where no roaming agreement is in place, then no mobile network access is normally possible. A further opportunity is to reach the Internet via WIFI access. This is spotty deployed and not everywhere available for everyone.

The initial next generation technology, 6G, building blocks such as trusted execution environments and seamless data access across locations are actively being discussed and required.

National and international roaming provides connectivity to the user equipment, UEs of operators who have roaming agreements between them. In order to be able to provide this, it is required that a proper roaming architecture is deployed in the visited and the home network. This agreement and network configuration is planned and applied in both operator networks with a certain effort in the network equipment, SLA etc.

FIG. 1 shows a schematic view of a simplified architecture in a roaming case. In a visited network function, NF, 11, an access management function, AMF 12, a non-3GPP interworking function, N3IWF, used for a WIFI access, a session management function 14, a network repository function, NRF 15, a security edge protection proxy, SEPP, 16 are involved in the visited network whereas in the home network a corresponding SEPP 17 is provided and involved together with an authentication server function, AUSF, a network repository function 19 and a unified data management, UDM 20.

Furthermore, it is possible that UEs may connect via a trusted or untrusted WLAN to the Internet as shown in FIG. 2. 3GPP defines trusted 3GPP access and trusted or untrusted NON-3GPP access (WIFI) in such away that nearly the same authentication and authorization procedures can be used in both cases. In FIG. 2 a UE 10 accesses a home network via a visited network using a non-3GPP, the WLAN, access or the normal access via the radio access network, wherein both access requests are transmitted through the access management function 21 in the visited network. In the home network, the authentication server function, AUSF is involved which checks the identity using the unified data management, UDM 23.

FIG. 3 shows the untrusted non-3GPP access, the WLAN access, to the home network in which a UE 10 uses the untrusted non-3GPP access 31 to access the home network via the N3IWF 33, the AMF 34, SMF 35, UPF 36, the 3GPP access 32 in order to access the data network 37.

International and national roaming needs a service level agreement and a costly network setup to deploy it. Accordingly not every network operator is interconnected like this. If the UE is out of the home network coverage and no roaming partner coverage applies, and additionally no WLAN is available, the UE is not connected to any network. In some areas roaming agreements may not justify the effort and are simply too costly for the expected amount of traffic. Even global policies may prevent these agreements. Mission critical subscribers such as police forces, humanitarian forces or peacekeeping delegations cannot seamlessly roam worldwide without these roaming agreements.

For vertical industries, there is currently no possibility to use the 3GPP access network if there is no roaming agreement between them, 3GPP defines the untrusted non-3GPP access where an authentication is asked for in the visited network. Furthermore in case of unmanned aerial vehicles, UAVs, the network in the air may have a different coverage compared to the network on the ground. This can mean that the UAV detects a lot of more suitable cells in the air and as a consequence new neighboring networks may appear and the terrestrial network may not be prepared for such a roaming situation.

Accordingly a need exists to overcome at least some of the above-mentioned problems and to provide an option to access a visited cellular network where no roaming agreement exists with the home network without using a WLAN access.

### SUMMARY

This need is met by the features of the independent claims. Further aspects are described by the dependent claims.

According to a first aspect a method for operating a user equipment operating in a visited cellular network is provided for which no roaming agreement exists between a home cellular network of the user equipment and the visited cellular network. The method comprises the step that the user equipment transmits an access request to the visited cellular network requesting access to the visited cellular network, wherein this access request comprises an identifier indicating to originate from a user equipment for which no roaming agreement exists with the home cellular network of the user equipment. Furthermore, a session establishment request is transmitted by the user equipment to the visited network to establish a data packet session in the visited cellular network. The user equipment furthermore determines an address of a gateway providing access to the home cellular network and a connection to the gateway is established based on the determined address via the visited cellular network.

Furthermore the corresponding user equipment is provided comprising a memory and at least one processing unit, wherein the memory comprises instructions executable by the at least one processing unit. The user equipment is operative to work as discussed above or as discussed in further detail below.

Furthermore a method is provided carried out by an access management entity in the visited cellular network. The method comprising the steps of receiving a service request from a user equipment which is connected to the visited cellular network wherein the user equipment is unknown to the visited cellular network and the service request comprises an identifier indicating to originate from a user equipment for which no roaming agreement exists with the home cellular network of the user equipment. The access management entity selects, based on the received identifier, a session management entity configured to manage a data packet session for the user entity in the visited cellular network without a prior authentication of the user equipment or a prior authorization of the user equipment. Furthermore, the access management entity transmits a handling request to the selected session management entity to handle the data packet session for the user equipment.

Furthermore the corresponding access management entity is provided comprising a memory and at least one processing unit, wherein the memory contains instructions executable by the at least one processing unit. The access management entity is operative to work as discussed above or as discussed in further detail below.

Furthermore a session management entity is provided in a visited cellular network wherein the session management entity receives a handling request from the access management entity of the visited cellular network to handle a data packet session for the user equipment, wherein no roaming agreement exists between the home cellular network of the user equipment and the visited cellular network. The session management entity furthermore receives a session establishment request from the user equipment, wherein a session establishment request comprises an identifier which indicates to originate from a user equipment for which no roaming agreement exists with the home cellular network of the user equipment. The session management entity then is setting up the data packet session for the user equipment to an access point to be used by the user equipment for a connection to its home network without a prior authentication of the user equipment or a prior authorization for the user equipment based on the received identifier.

Furthermore a method is provided carried out by a gateway located in the home network of the user equipment. The gateway receives, from the user equipment connected to a visited cellular network, an encrypted authentication request, the encrypted authentication request comprising a registration request for a registration of the user equipment to the home cellular network, the registration request comprising at least one network parameter related to the home network, and requests to set up an data packet session through the home network. The gateway decrypts the encrypted authentication request and identifies the registration request, selects an access management entity in the home network taking into account the at least one network parameter, and transmits the registration request to the selected access management entity.

The user equipment transmitting the identifier can thus have access to a cellular network for which no roaming agreement exists and the UE can access the home network via the gateway. Based on the identifier received, network components in the visited network such as the access management entity or the session management entity can carry out the corresponding tasks without asking for an authorization or authentication of the user equipment in the visited cellular network. Accordingly even when the coverage to the home network is lost it is possible to access a data network such as the Internet using another cellular network for which no agreement with the home network exists.

Furthermore, a system is provided comprising at least two of the entities mentioned above.

Furthermore, a computer program comprising program code is provided to be executed by the at least one processing unit, where an execution of the program code causes the at least one processing unit to carry out a method as mentioned above or as discussed in detail below. The processing unit may be provided in a user equipment, a session management entity, an access management entity or a gateway.

It is to be understood that the features mentioned above and features yet to be explained below can be used not only in the respective combinations indicated, but also in other combinations or in isolation without departing from the scope of the present invention. Features of the above-mentioned aspects and embodiments described below may be combined with each other in other embodiments unless explicitly mentioned otherwise.

### BRIEF DESCRIPTION OF THE DRAWINGS

The foregoing and additional features and effects of the application will become apparent from the following detailed description when read in conjunction with the accompanying drawings in which like reference numerals refer to like elements.

FIG. 1 shows a schematic architectural view of an interworking between a visited and a home network in a roaming situation as known in the art.

FIG. 2 shows a schematic view of the different access possibilities to a home network via WLAN or a 3GPP access and the corresponding authentication.

FIG. 3 shows a schematic architectural view of a situation in which a user equipment accesses a home network using an untrusted non-3GPP access.

FIG. 4 shows a schematic high-level architectural view of an access of a user equipment to a visited network in which no roaming agreement exists to the home network of the user equipment.

FIG. 5 shows a more detailed solution of the access of the user equipment to the visited network having no roaming agreement with the home network of the user equipment.

FIG. 6 shows a schematic view of a message exchange between the involved entities for a situation when a user equipment access a visited network without a roaming agreement to access a home network.

FIG. 7 shows a further architectural view of the situation when a user equipment connects to a VPN gateway using an untrusted 3GPP access.

FIG. 8 shows a schematic view of a message exchange between the involved entities in a situation as shown in FIG. 7.

FIG. 9 shows an example flowchart of a method carried out by a user equipment when accessing a cellular network for which no roaming agreement exists.

FIG. 10 shows an example flowchart of a method carried out at an access_management entity in a visited network when a user equipment accesses the visited network in a roaming scenario and no roaming agreement exists between the two networks.

FIG. 11 shows an example flowchart of a method carried out at a session_management entity in a visited network when the user equipment accesses the visited network in a roaming scenario and no roaming agreement exists between the two networks.

FIG. 12 shows an example flowchart of a method carried out at a VPN gateway when a user equipment accesses the visited network in a roaming scenario and no roaming agreement exists between the two networks.

FIG. 13 shows an example schematic representation of a user equipment configured to connect to a visited cellular network when no agreement exists to the corresponding home network of the user equipment.

FIG. 14 shows another example schematic representation of the user equipment configured to connect to a visited cellular network when no roaming agreement exists with the corresponding home network of the user equipment.

FIG. 15 shows an example schematic representation of an access management entity in a visited cellular network which handles messages relating to a user of another network for which no roaming agreement exists.

FIG. 16 shows another example schematic representation of an access management entity in a visited cellular network which handles messages related to a user equipment of another cellular network for which no roaming agreement exists.

FIG. 17 shows an example schematic representation of a session management entity in a visited cellular network setting up a data packet session for a user equipment of another cellular network for which no roaming agreement exists.

FIG. 18 shows a further example schematic representation of a session management entity in a visited cellular network setting up a data packet session for a user equipment of another cellular network for which no roaming agreement exists.

FIG. 19 shows an example schematic representation of a VPN gateway connecting a user equipment connected to a visited network for which no roaming agreement exists to a home network.

FIG. 20 shows another example schematic representation of a VPN gateway connecting a user equipment connected to a visited network for which no roaming agreement exists to a home network.

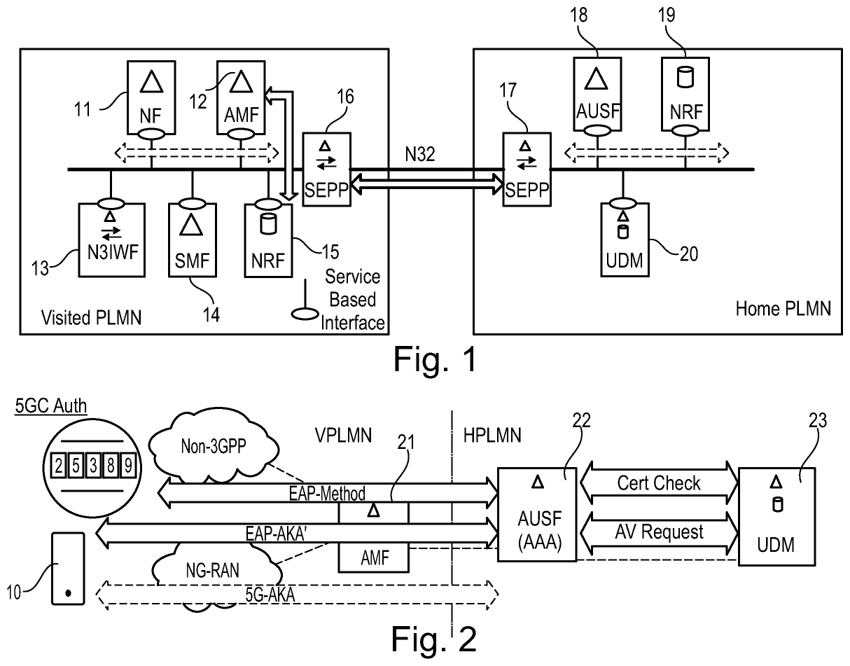

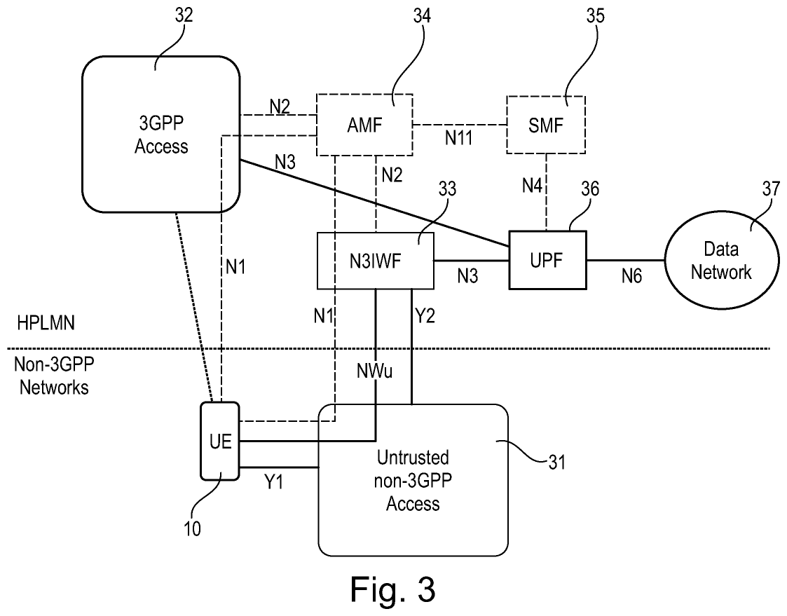

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

Within the context of the present application, the term “mobile entity” or “user equipment” (UE) refers to a device for instance used by a person (i.e. a user) for his or her personal communication. It can be a telephone type of device, for example a telephone or a Session Initiating Protocol (SIP) or Voice over IP (VoIP) phone, cellular telephone, a mobile station, cordless phone, or a personal digital assistant type of device like laptop, notebook, notepad, tablet equipped with a wireless data connection. The UE may also be associated with non-humans like animals, plants, or machines. A UE may be equipped with a SIM (Subscriber Identity Module) or electronic-SIM comprising unique identities such as IMSI (International Mobile Subscriber Identity), TMSI (Temporary Mobile Subscriber Identity), or GUTI (Globally Unique Temporary UE Identity) associated with the user using the UE. The presence of a SIM within a UE customizes the UE uniquely with a subscription of the user.

The solution discussed below proposes a new mechanism to ensure that if there is a mobile network coverage available, a user equipment, UE can access its home network and the corresponding services anywhere in the world.

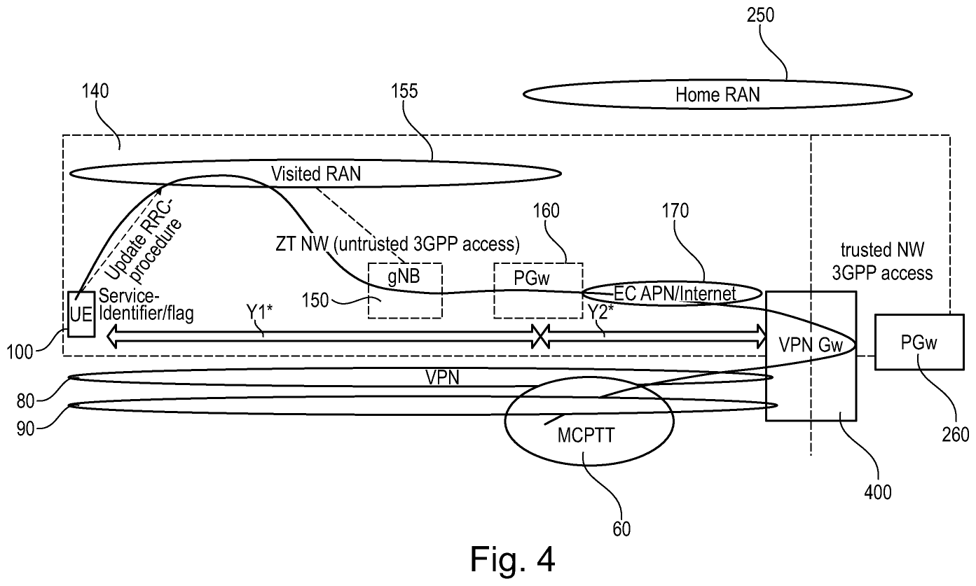

A high level architecture of the solution is shown in FIG. 4, in which a UE 100 connects to virtual private network, VPN gateway 400 via a radio access network 140 of a visited cellular network for which no roaming agreement exists between the home network of the UE 100 and the visited cellular network. In FIG. 4 the elements shown in dashed lines are elements from the visited cellular network and thus the roaming network wherein the solid lines indicate elements from the home network.

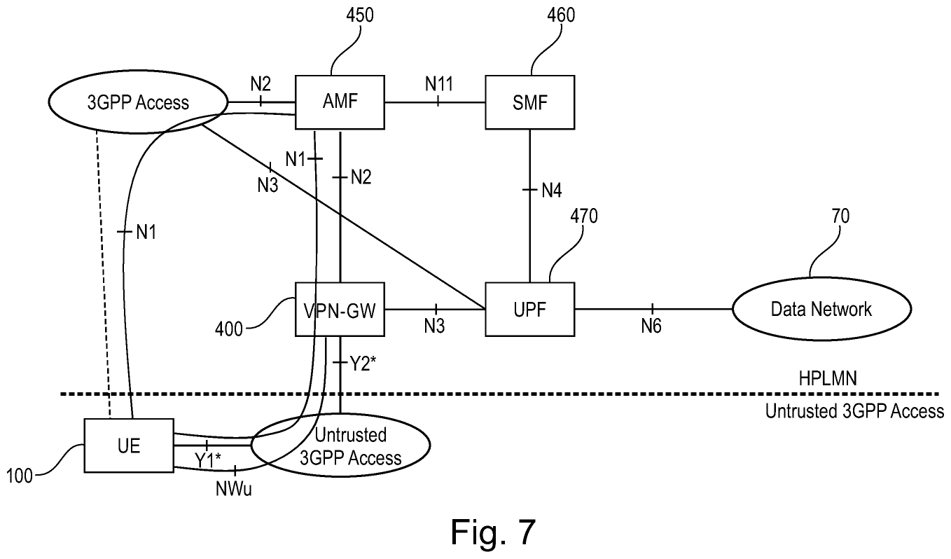

The UE 100 requests an access point from the visited network to access the VPN gateway 400 in the home network. To this end a request is sent via the visited radio access network 155 passed through the GNB 150, the packet gateway 160 and EC APN (Access Point Name)/Internet 170. As will be explained below, a VPN connection 80 is set up between the UE to VPN gateway 400 and a VPN connection 90 passing through mission-critical push to talk, MCPTT, 60 in case this push to talk functionality is required. In the home network, packet gateway 260 is provided. Accordingly the UE has set up an encrypted tunnel to the VPN gateway (GW). Then this tunnel allows via the VPN GW to access a VPN which can be the upper or lower tunnel shown in FIG. 4. Within this VPN connection there might exist services like MCPTT. As an example the VPN GW might connect the UE for fire brigade to the fire brigade VPN and the UE of the police to the police VPN. Within each VPN there might be other services. A further step not shown would be an access to the home AMF also sitting in the VPN and by this registering in the home network, services of the home network such as SMS or IMS would be available, as shown in FIG. 7 explained below.

Visited 3GPP access network is capable of providing the new service requested (a non-trusted 3GPP access) and provides connectivity to the VPN gateway of the home network. Accordingly, the VPN gateway makes it possible to use authentication and authorization procedures as known. Accordingly, access to services located in the VPN is provided as shown in FIG. 4 and services provided by the home network (FIG. 7) is provided in scenarios where no home network is available and no international or national roaming agreements are in place and no WLAN is available.

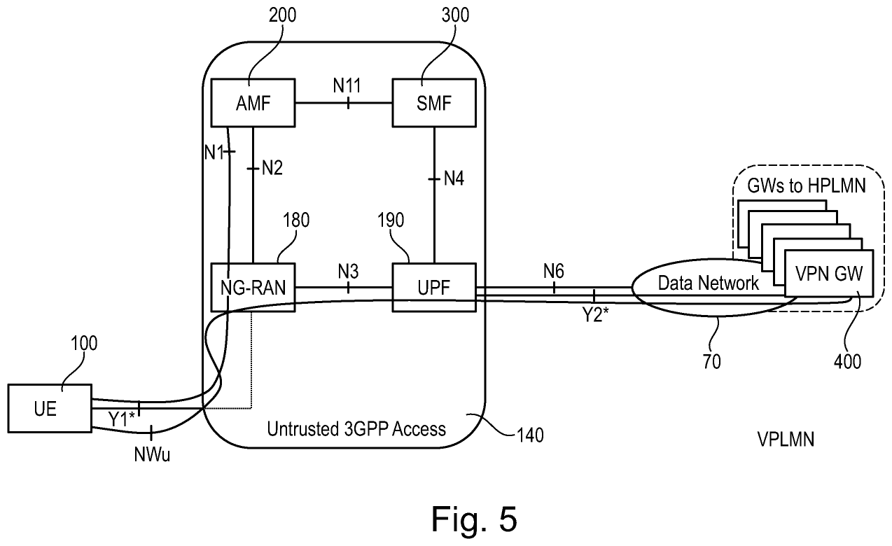

FIG. 5 shows how the untrusted 3GPP access network 140 provides the untrusted 3GPP access for UE 100. UE can access the VPN gateway 400 through a data network 70 such as the Internet. In the untrusted access network 140 the radio access network 180 is provided, the access management function or entity 200 and the session management function or session management entity 300. The user data passed through the user plane function, UPF, 190 to the VPN gateway 400.

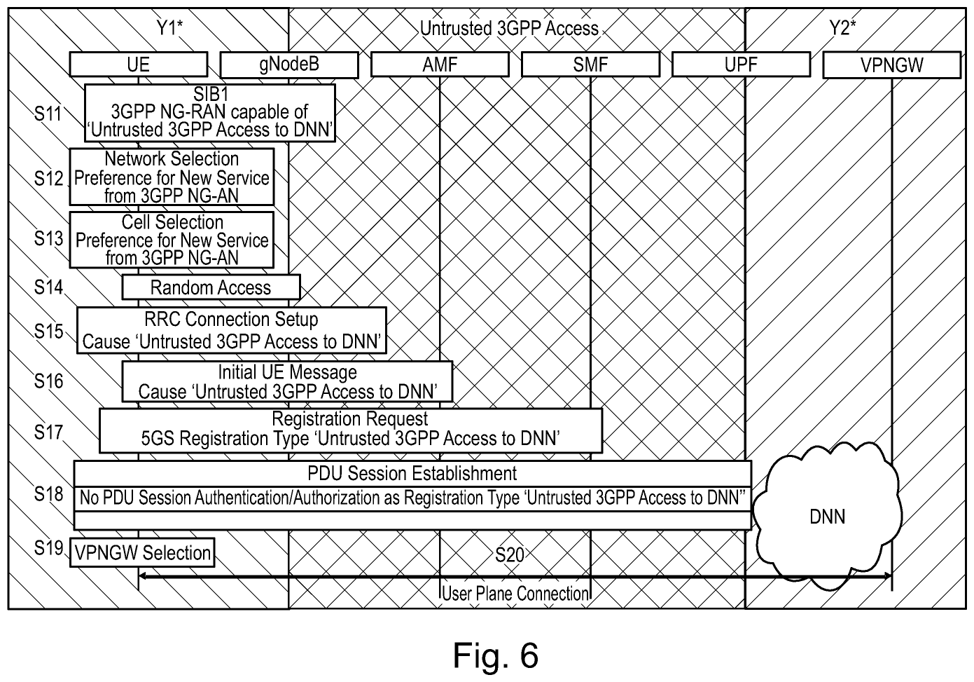

FIG. 6 shows the message exchange and an overview of the involved procedures when a UE 100 connects to a visited network and in step S11 the radio access network of the visited network is capable to provide a new service which is called “untrusted 3GPP access to DNN” to its users. This service offer may be broadcast via system information in the cells. Step S11 is optional and the UE could also try and error to access the radio access network of the visited network for which no roaming agreement exists. Furthermore, it is possible that the UE directly knows that this service is offered by the radio access network, the 3GPP radio access network of the visited network.

In step S12 the UE is looking for suitable cells to camp on and will detect that its home network is not available and that no equivalent network exists to visit. During its process of network selection the UE will prioritize a preference for radio access networks which offer this new service. Accordingly as the network includes the service identifier which indicates that this visited cellular network is supporting this service and access for user equipment which cannot be authenticated, the UE will use this service when the home network is not available and no other roaming network. In step S13 the cell selection will take the cell which can offer this new service.

In step S14 the random access procedure is carried out to this selected cell and a connection setup message is sent such as a radio resource control message, RRC connection setup with the message 3 as known from the 3GPP random access procedure. In step S15 the UE asked for the radio resource control, RRC connection indicating the cause of the untrusted 3GPP access to the DNN which is sent to the radio access network. Accordingly, the UE transmits an identifier which indicates that the message originates from a user equipment for which no roaming agreement exists with the home cellular network of the user equipment. In step S16 the initial UE message procedure from the user equipment includes this identifier, namely the cause of the untrusted 3GPP access to the visited network.

In step S17 the UE 100 requests the registration in the core network for the new service of the untrusted 3GPP access. This means that for this new service there will be no authorization or authentication from the visited network which would otherwise be initiated or triggered by the visited network. This means that neither the access management entity, AMF nor session management entity, SMF, will ask for an authorization or an authentication for a user equipment which accesses the visited network under the condition indicated above.

In step S18 the user equipment 100 will trigger a session establishment request such as a PDU session establishment to the core network, the SMF and UPF. In this process, it will get the IP address allocated and also the connection to the DNN where all the VPN gateways are located. This could be implemented by a certain access point name, APN which is only capable to connect to the plurality of VPN gateways. This PDU Session Establishment Request is for the new service concerning the registration type of the untrusted 3GPP access to the DNN so that the SMF will not perform the secondary PDU session authentication or authorization. The SMF may choose a predefined PCF for this PDU session.

In step S19 the visited cellular network, PLMN, is providing the connectivity to the home network of the subscriber. The UE is able to connect to the VPN gateway. The IP address of the VPN gateway could be obtained by different mechanisms such as the storing on the SIM card of the UE, or it may be received from the DNN DNS or may be piggy-backed in the network access stratum, NAS, message from the core network administered pool. In step S20, the user plane connection between the UE and the VPN gateway is set up and established.

The UE is capable to request this new service of the untrusted 3GPP access from the visited network. One way of introducing the charging of the service could be done by the visited network which looks up the operator of the destination IP address of the VPN gateway in order to charge for its service. The to be charged operator needs to look up who used a service via the VPN gateway and charges the specific subscribers. In case the home network does not provide charging details or confirms its own subscriber service request the connection may be torn down. However, also other more generic charging models could be applied.

The home network could be reached via a standardized NWu interface. From then on similar procedures apply as for the N3IWF for untrusted non-3GPP access.

FIG. 7 indicates in further detail how the UE connects from the untrusted 3GPP access to the VPN gateway 400 in the home network and in comparison to untrusted non-3GPP access and the involved entities, the AMF 450, the SMF 460 and the UPF 470.

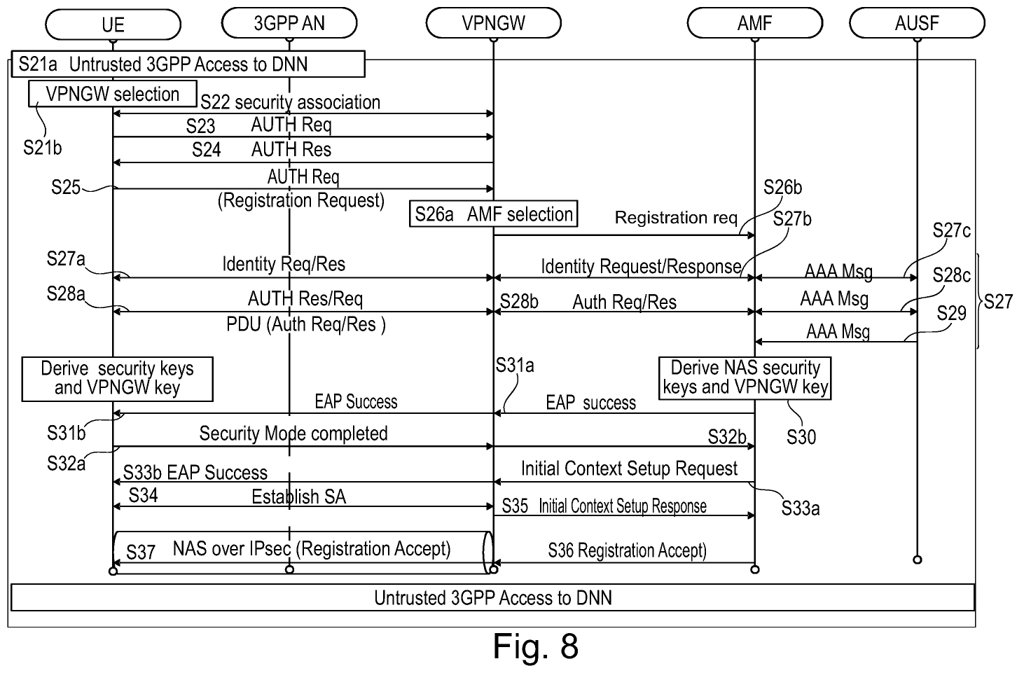

FIG. 8 shows the registration to the home network via the untrusted 3GPP access to the DNN service, wherein a possible implementation of the messages is mentioned in parentheses.

The VPN gateway 400 sets up a secure connection via the visited untrusted 3GPP network to the UE.

The following steps are carried out using an IKE (Internet Key exchange) protocol as an example of an encrypted message exchange, however it should be understood that other protocols might be used.

S21a, S21b, S22: UE initiates the IKEv2 initial exchange with the selected VPN-GW for the establishment of an IKE SA (security association). All subsequent IKE messages are encrypted and integrity-protected using the established IKE SA (S22: IKE SA INIT).

S23: UE sends the IKE AUTH request without the AUTH payload indicating use of EAP-5G. The IKE AUTH request may also include a Notify payload to indicate MOBIKE support and a CERTREQ payload to request VPN-GW certificate (S23: IKE AUTH Req).

S24: VPN-GW responds with an IKE AUTH response, including EAP-Request/5G-Start packet informing UE to start sending NAS (Non Access Stratum) messages. The IKE AUTH response will include the VPN-GW certificate if it has received the CERTREQ payload (S24: IKE AUTH Res (EAP Req/5G Start)).

S25: UE sends the IKE AUTH request including EAP-Response/5G-NAS with NAS registration request and AN parameters (GUAMI, selected PLMN ID, Requested NSSAI and the Establishment Cause). All subsequent NAS messages between UE and VPN-GW are encapsulated within EAP/5G-NAS packets. (S25: IKE AUTH Req (EAP Res/5G NAS/AN Params/NAS PDU (Registration Request))

S26a,b: VPN-GW selects an AMF based on the received AN parameters and local policy and forwards the registration request received from the UE to the selected AMF within an N2 Initial UE message. All NAS messages between UE and AMF are transparently relayed by VPN-GW S26b: Initial UE message (NAS PDU-Registration Request).

AMF may request the SUCI from the UE with a NAS Identity request that is received back in a NAS Identity Response from the UE. This identity request is from the home network to the UE (_{[RD1]}then S27a) and the UE sends an identity response back (S27a other direction) followed by S27b other direction, then followed by S27c to AUSF with the identity.

S27a-c, S28a-c: AMF selects an AUSF to authenticate the UE based on SUCI or SUPI. The AUSF further selects a Unified Data Management (UDM) to obtain authentication data and executes the EAP-AKA′/5G-AKA authentication with the UE (S27a:IKE ATH Res/Req (EAP Req/Res/5G NAS/NAS PDU (Identity Req/res)), S27b: DL/UL NAS Message (Identity Request/Response), S27c: AAA Msg [SUPI or SUCI], S28a: IKE AUTH Res/Req (EAP Req/Res/5G NAS/NAS PDU (Auth Req/Res [EAP AKA Challenge], S28b: DL/UL NAS Message (Auth Req/Res [EAP AKA Challenge]). S28c: AAA Msg [EAP AKA Challenge]))

S29: After successful authentication, the AUSF sends the EAP Success Security anchor key (SEAF key) to AMF (S29: AAA Msg [EAP success, SEAF, SUPI]) which derives (S30) the NAS security keys and VPN-GW security key.

S31a-b: AMF encapsulates the EAP-Success received from AUSF within the NAS Security Mode Command message and sends it to the UE to activate NAS security (S31a: DL NAS Message (NAS Security mode command [EAP success]), S31b: IKE AUTH Res(EAp Req/5G NAS/NAS PDU (NAS security mode command [EAP-Success])).

S32a, b: UE also derives the SEAF key, NAS security keys and VPN-GW key and sends a NAS Security Mode Complete message to the AMF (S32a: IKE AUTH Req(EAP Res/5G NAS/NAS PDU (NAS security mode complete)) S32b: UL NAS message (NAS Security mode complete)).

S33a,b: AMF further sends an NGAP Initial Context Setup Request message including the VPN-GW key to the VPN-GW which triggers the VPN-GW to send an EAP-Success to UE, which completes the EAP-5G session (S33: Initial Context Setup Request (VPNGW Key), S33b: IKE AUTH Res (EAP-Success)).

S34: One IP sec SA is established between the UE and VPN-GW using the common VPN-GW key in tunnel mode with the allocation of an inner IP address for UE and NAS IP address for VPN-GW. All subsequent NAS messages between UE and VPN-GW are encapsulated within the established Signaling IPsec SA (S34: Establish IPsec SA for NAS signaling).

S35: VPN-GW notifies the AMF that the UE context is created by sending a NGAP Initial Context Setup Response (Initial Context Setup Response (EAP Success).

S36, S37: AMF sends the NAS Registration Accept message including the Allowed NSSAI for the access type for the UE to the VPN-GW which forwards the same to the UE through the signaling IPsec SA (S36: DL NAS Message (Regitration Accept), S37: NAS over IPsec (Registration Accept).

FIG. 8 and the previous figures were discussed in connection with 5G network. However, it should be understood that a similar approach could be used in a 4G network.

In the following, we will summarize some of the major steps carried out by the different entities in the embodiments described above.

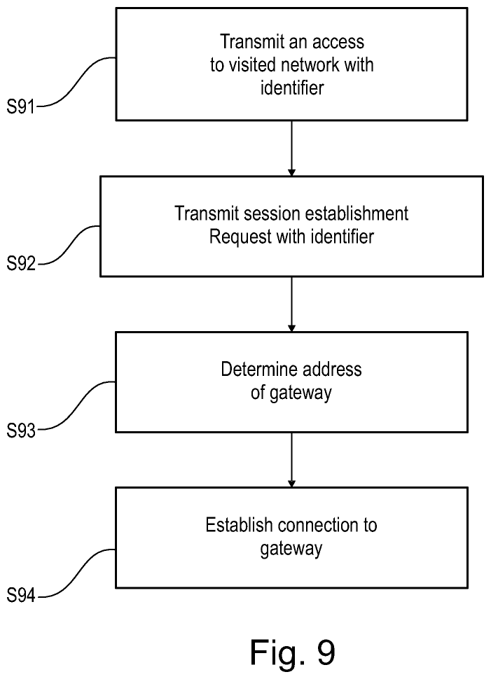

FIG. 9 describes some of the steps carried out by the user equipment 100 when user equipment is trying to access a home cellular network through a visited cellular network for which no roaming agreement exists with the home network of the UE 100. In step S91 the user equipment transmits an access request to the visited cellular network, in which the UE requests an access to the visited cellular network. This access request comprises an identifier which indicates that the request is originating from the user equipment for which no roaming agreement exists with the home cellular network. The corresponding step was discussed in further detail in connection with FIG. 6, step S15 wherein the identifier corresponds to the indication of the untrusted 3GPP access. Furthermore, in step S92 a session establishment request is transmitted to the visited network to establish a data packet session in the visited cellular network. This was discussed in further detail in connection with FIG. 6 step S18. Furthermore, in step S93 an address of a gateway is determined which provides access to the home cellular network or to the VPN where the home services and the home PLMN core network can be reached. and in step S94 a connection is established to the gateway based on the determined address via the visited cellular network. This was discussed above in connection with step S19 and S20.

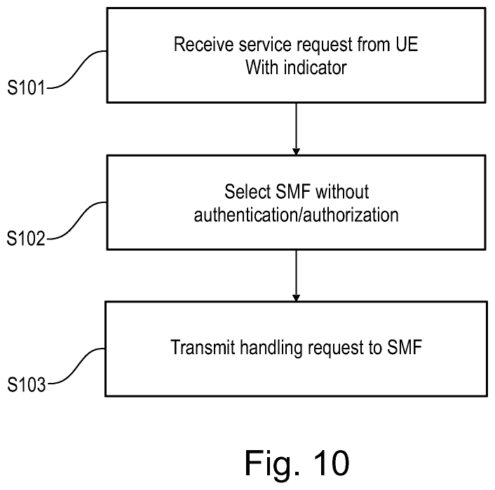

FIG. 10 describes the corresponding steps as they are carried out by an access management entity 200 located in the visited cellular network which receives the UE request. In step S101 the access management entity receives the service request from the user equipment which is connected to the visited network but which is unknown to the visited network. This service request comprises the identifier which indicates to originate from a user equipment for which no roaming agreement exists with the home cellular network of the user equipment. As discussed above in connection with FIG. 6 step S16, the access management entity then selects, based on the received identifier, a session management entity which is configured to manage a data packet session for the user entity in the visited network wherein this step is carried out without a prior authentication or an authorization for the user equipment. The access management entity then transmits a handling request to the selected session management entity to handle the data packet session for the user equipment. This was discussed above in connection with FIG. 6 in connection with step S17.

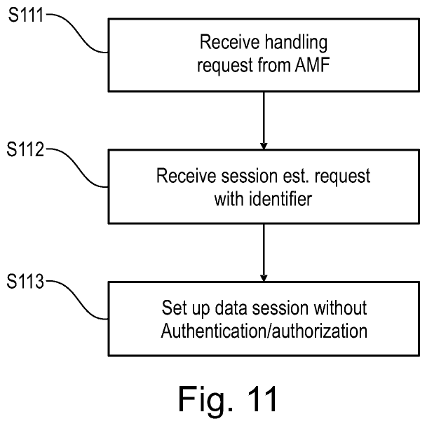

FIG. 11 describes the steps carried out by the session management entity 300 in the visited cellular network in the situation shown and discussed above in connection with FIG. 6. The session management entity receives in step S111 the handling request from the access management entity 200 of the visited cellular network to handle a data packet session for a user equipment, however no roaming agreement exists between the home network of the user equipment and the visited network. This was discussed above in connection with step S16. The session management entity furthermore receives a session establishment request in step S112 from the user equipment wherein this session establishment request comprises an identifier which indicates to originate from a user equipment for which no roaming agreement exists with the home network of the user equipment. This was discussed above in connection with step S17 wherein the identifier was implemented by the untrusted 3GPP access to the DNN. Under other circumstances, the session management entity would authenticate the user equipment and ask for an authorization. Based on the received identifier, this authentication or authorization is omitted. In S113 the session management entity sets up the data packet session for the user equipment wherein the data packet session is set up to an access point which is used by the user equipment for a connection to its home network. Again, this setting up of the data packet session is carried out without a prior authentication or authorization of the UE 100.

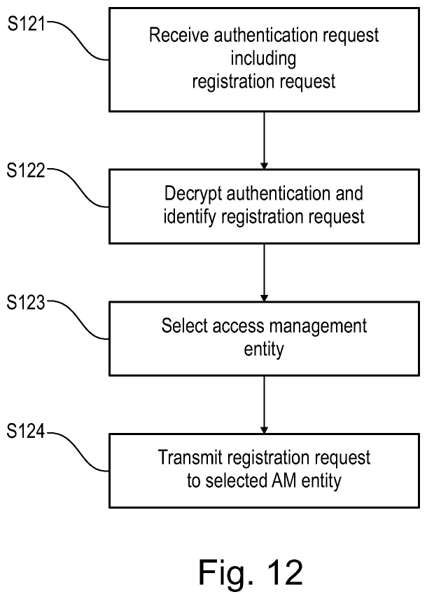

FIG. 12 describes the steps of the VPN gateway carried out in the situation discussed in connection with FIGS. 6 and 8. This step S121, the gateway receives from the user equipment which is connected to the visited network an encrypted authentication request. This encrypted authentication request comprises a registration request for a registration of the user equipment to the home cellular network. The registration request furthermore comprises at least one network parameter related to the home network and a request to set up a data packet session through the home network. As discussed above in connection with FIG. 8 step S25. In step S122 the encrypted authentication request is decrypted and the corresponding registration request contained in the authentication request is identified. Accordingly, in step S123 the gateway selects an access management entity in the home network based on the at least one network parameter received from the user equipment as discussed in step S26a. The gateway then transmits the registration request in step S124 to the selected access management entity as discussed above in step S26b.

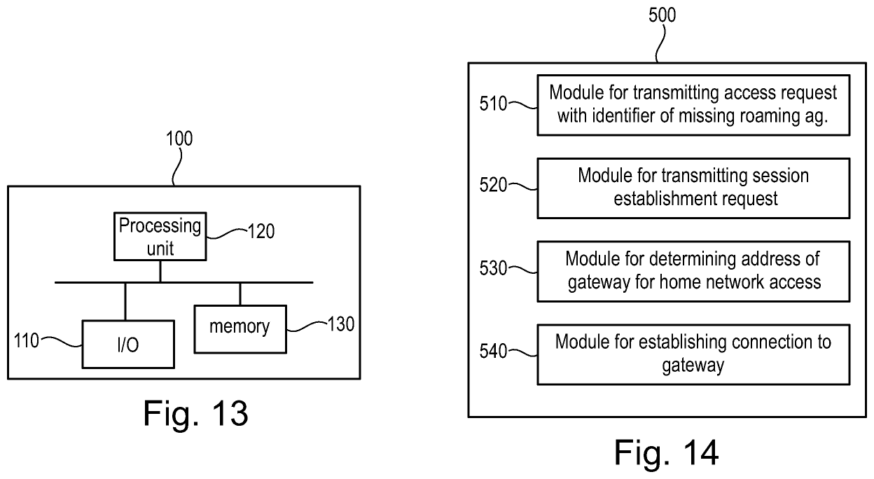

FIG. 13 shows a schematic architectural view of a user equipment 100 which can carry out the above-mentioned steps in which the UE is involved as shown in connection with FIG. 6 to 8. The user equipment 100 comprises an interface 110 which is provided for transmitting user data or control messages to other entities and configured to receive user data and control messages from other entities. The interface can inter alia used to transmit call data and the access request to the visited network. The user entity furthermore comprises a processing 120 which is responsible for the operation of the user equipment 100. The processing unit 120 comprises one or more processors and can carry out instructions stored on a memory 130, wherein the memory may include a read-only memory, a random access memory, a mass storage, a hard disk or the like. The memory can furthermore include suitable program code to be executed by the processing unit 120 so as to implement the above-described functionalities in which the user equipment is involved.

FIG. 14 shows another architectural schematic view of a user equipment involved in the situation discussed in connection with FIG. 6 to 8. The user equipment 500 comprises a first module 510 which is configured to transmit the access request including the identifier which indicates that no roaming agreement exists with the requesting UE. A module 520 is provided for transmitting the session establishment request set up the data packet session in the visited cellular network. A module 530 is provided configured to determine an address of the gateway which provides to the home cellular network and a module 540 is configured to establish a connection to the gateway based on the determined address via the visited cellular network.

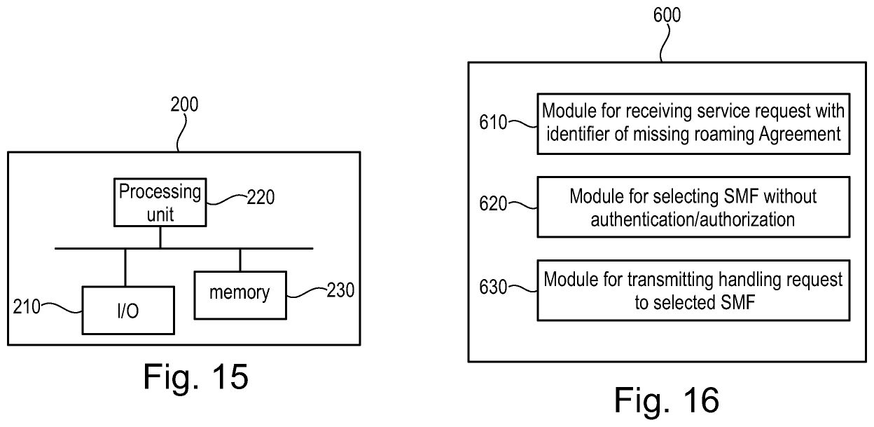

FIG. 15 shows a schematic architectural view of an access management entity 200 located in the visited network and involved in the steps discussed in connection with FIG. 6. The access management entity comprises an interface 210 provided for transmitting user data or control messages to other entities and provided for receiving user data or control messages from other entities. The access management entity furthermore comprises a processing unit 220 responsible for the operation of the access management entity 200. The processing unit 220 comprises one or more processors and can carry out instructions stored on a memory 230, wherein the memory may include a read-only memory, a random access memory, a mass storage, a hard disk or the like. The memory can furthermore include suitable program code to be executed by the processing unit 220 so as to implement the above described functionalities in which the access management entity in the visited network is involved.

FIG. 16 shows a further schematic architectural view of the access management entity 600 located in the visited network which comprises a first module 610 configured to receive the service request with the identifier which indicates that no roaming agreement exists for the requesting UE. A module 620 is provided configured to select a session management entity for the user equipment wherein this step is carried out without a prior authentication of the user equipment or an authorization for the user equipment. A module 630 is provided configured to transmit the handling request to the selected session management entity to handle the data packet session for the user equipment.

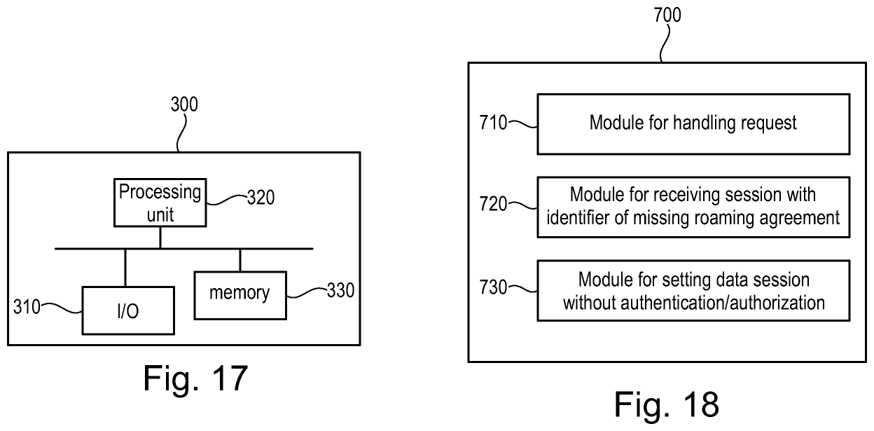

FIG. 17 shows a schematic architectural view of a session management entity 300 involved in the situation discussed in connection with FIG. 6. The session management entity comprises an interface 310 for transmitting user data or control messages to other entities and configured to receive user data or control messages from other entities. The session management entity furthermore comprises a processing unit 320 which is responsible for the operation of the session management entity 300. The processing unit 320 comprises one or more processors and can carry out instructions stored on a memory 230, wherein the memory may include a read-only memory, a random access memory, a mass storage, a hard disk or the like. The memory can furthermore include suitable program codes to be executed by the processing unit 320 as to implement the above described functionalities in which the session management entity is involved.

FIG. 18 shows a further schematic architectural view of a session management entity 700 the session management entity 700 handles the data packet session for the UE in the visited network and comprises a first module 710 configured to receive a handling request from an access management entity of the visited network to handle a data packet session for the user equipment, however no roaming agreement exists between the home network of the user equipment and the present visited network. A module 720 is provided configured to receive a session establishment request from the UE which comprises the identifier which indicates that the request is originating from a user equipment for which no roaming agreement exists with the home network of the user equipment. A module is 730 is configured to set up a data packet session for the user equipment to an access point which is used by the user equipment for a connection to its home network, wherein this setting up is carried out without the fact that the UE is authenticated or an authorization is asked for.

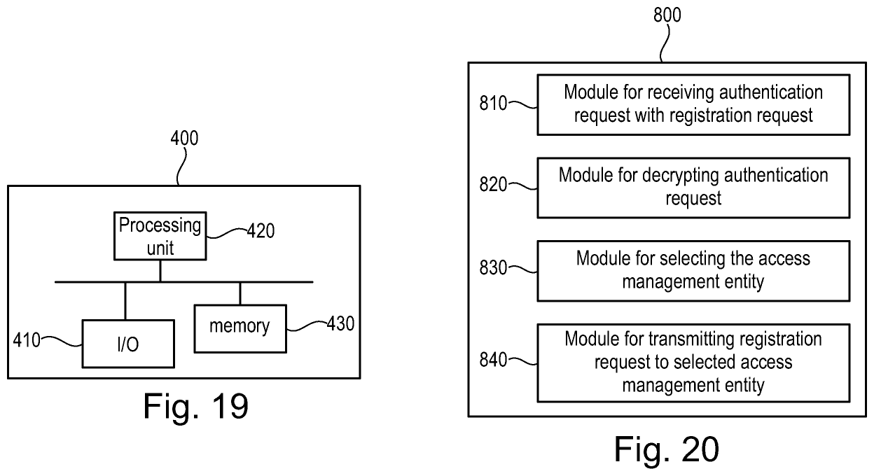

FIG. 19 shows a schematic architectural view of the gateway, the VPN gateway which is involved in the steps shown in FIG. 6 to 8. The gateway 400 comprises an interface 410 provided for transmitting user data or control messages to other entities and configured to receive user data and control messages from other entities. The gateway furthermore comprises a processing unit 420 responsible for the operation of the gateway 400. The processing unit 420 comprises one or more processors and can carry out instructions stored on a memory 430, wherein the memory may include a read-only memory, a random access memory, a mass storage, a hard disk or the like. The memory can furthermore include suitable program code to be executed by the processing unit 420 so as to implement the above described functionalities in which the gateway is involved.

FIG. 20 shows a further schematic architectural view of the gateway 800. The gateway comprises a first module 810 configured to receive the encrypted authentication request from the user equipment which is connected to the visited cellular network. A module 820 is provided configured to decrypt the authentication request and to identify the registration request contained in the authentication request. A module 430 is configured to select an access management entity in the home network taken into account the network parameter which was present in the authentication request. A module 840 is provided configured to transmit the registration request to the selected access management entity.

From the above said some general conclusions can be drawn:

As far as the user equipment 100 is concerned, when the access request is transmitted to the visited network, the UE can transmit a first access request requesting access to a radio part of the visited network and can transmit a second request requesting registration of the user equipment to the visited cellular network, and each of these requests comprises the identifier which indicates to originate from the user equipment for which no roaming agreement exists. This was discussed above in FIG. 6 in steps S15 and S17.

The second access request can request the visited network to inform the user equipment of an access point in the visited network to be used by the user equipment for the connection to the gateway. The access point can be the DNN in a 5G environment or APN (access point name) for a 4G network.

The address of the gateway could be determined in the following ways: It could be retrieved from a memory of the user equipment, from the address from a domain name server and/or could be retrieved from a signaling message received from the visited cellular network.

Furthermore it is possible that the UE determines a presence of a first condition that neither the home network is available nor a further network for which a roaming agreement exists between the home cellular network and the further cellular network. In addition a second condition may be determined that the visited network is supporting access for the user equipment for which no roaming agreement exists. The access request may be transmitted to the visited cellular network when it is determined that at least one of the first the second condition is presently fulfilled.

The second condition may be determined based on a broadcast message received from the visited network and this broadcast message includes the service identifier which identifies that the visited cellular network is supporting a service providing access of not authenticated user equipments.

The UE may furthermore select a radio cell of the visited cellular network for an access to the radio part of the visited cellular network based on a service identifier from the visited cellular network indicating that the visited cellular network is supporting access of mobile entities for which no roaming agreement is in place with the home cellular network of the user equipment. In other words, the service identifier indicates that the network is supporting a service providing access for not authenticated authorized user equipments.

The access request from the UE to the visited cellular network is a 3GPP access to the visited cellular network.

When a connection is established to the gateway, an authenticated and encrypted tunnel to the gateway may be established. Furthermore, it is possible that when the connection to the gateway has been set up, register procedure is started with the home cellular network.

As far as the gateway, the VPN gateway 400 located in the home network is concerned, the latter receives the encrypted authentication request and identifies the registration request including the network related parameter. The network related parameter may include one of the following pieces of information:

A network identifier identifying the home cellular network, an Access identifier identifying the access management entity, a slice identifier identifying network slice within the home cellular network, and a cause identifier identifying a course for the registration request.

The gateway may furthermore receive a successful authentication for the user equipment in which a successful authentication of the was equipment is confirmed. This successful authentication may be received using a first protocol and this successful authentication is then forwarded to the user equipment through the visited network using a second protocol which was also used for the encrypted communication with user equipment in the visited cellular network.

Furthermore, the gateway may generate a secure and encrypted communication channel from the gateway to the user equipment through the visited cellular network.

The solution discussed above has several advantages. If the coverage of the home cellular network is lost, it is nevertheless possible to access another network wherein the other network may be another national or international PLMN. For unmanned aerial vehicles the network coverage in the air could possibly provide unexpected neighboring cells and in this context these neighboring cells could be used to control the unmanned aerial vehicle. Furthermore, a mission-critical communication is improved, as an access to the home network is possible without roaming agreements. By way of example, a central server may be available and accessible and humanitarian missions become available with network access anywhere in the world. Furthermore, new business models could be realized for the UE and VPN gateway provided as over-the-top service using the untrusted 3GPP access. Furthermore, network services can be launched more easily.

1. A method for operating a user equipment operating in a visited cellular network for which no roaming agreement exists between a home cellular network of the user equipment and the visited cellular network, the method comprising at the user equipment:
transmitting an access request to the visited cellular network requesting access to the visited cellular network, the access request comprising an identifier indicating to originate from a user equipment for which no roaming agreement exists with the home cellular network of the user equipment;
transmitting a session establishment request to the visited network to establish a data packet session in the visited cellular network;
determining an address of a gateway providing access to the home cellular network; and
establishing a connection to the gateway based on the determined address via the visited cellular network.

2. The method of claim 1, wherein transmitting the access request comprises transmitting a first access request requesting access to a radio part of the visited cellular network and a second request requesting registration of the user equipment in the visited cellular network, each of the first and second access request comprising the identifier.

3. The method of claim 2, wherein the second access request requests the visited network to inform the user equipment of an access point in the visited cellular network to be used by the user equipment for the connection to the gateway.

4. The method of claim 1, wherein determining the address of the gateway comprises at least one of the following:
retrieving the address from a memory or SIM of the user equipment;
retrieving the address from a domain name server;
retrieving the address from a signaling message received from the visited cellular network.

5. The method of claim 1, further comprising:
determining a presence of a first condition that neither the home cellular network is available nor a further network for which the roaming agreement exists between the home cellular network and the further cellular network; and
determining a second condition that the visited cellular network is supporting access for a user equipment for which no roaming agreement exists, wherein the access request is transmitted to the visited cellular network when it is determined that at least one of the first and second condition is presently fulfilled.

6. The method of claim 5, wherein the second condition is determined based on a broadcast message received from the visited network, the broadcast message including a service identifier indicating that the visited cellular network is supporting a service providing access of not authenticated user equipment.

7. The method of claim 1, further comprising selecting a radio cell of the visited cellular network for an access to the radio part of the visited cellular network based on a service identifier from the visited cellular network indicating that the visited cellular network is supporting access of mobile entities for which no roaming agreement is in place with the home cellular network of the user equipment.

8. The method of claim 1, wherein the access request is a request for a 3GPP access to the visited cellular network.

9. The method of claim 1, wherein establishing a connection to the gateway comprises establishing an authenticated and encrypted tunnel to the gateway.

10. The method of claim 1, wherein when the connection to the gateway has been set up, starting a register procedure with the home cellular network.

11. (canceled)

12. (canceled)

13. A user equipment configured to operate in in a visited cellular network for which no roaming agreement exists between a home cellular network of the user equipment and the visited cellular network, the user equipment comprising a memory and at least one processing unit, the memory comprising instructions executable by the at least one processing unit, to cause the user equipment to:
transmit an access request to the visited cellular network requesting access to the visited cellular network, the access request comprising an identifier indicating to originate from a user equipment for which no roaming agreement exists with the home cellular network of the user equipment;
transmit a session establishment request to the visited network to establish a data packet session in the visited cellular network;
determine an address of a gateway providing access to the home cellular network; and
establish a connection to the gateway based on the determined address via the visited cellular network.

14. The user equipment of claim 13, being further caused to transmit a first access request requesting access to a radio part of the visited cellular network and a second request requesting registration of the user equipment in the visited cellular network, each of the first and second access request comprising the identifier.

15. The user equipment of claim 14, wherein the second access request requests the visited network to inform the user equipment of an access point in the visited cellular network to be used by the user equipment for the connection to the gateway.

16. The user equipment of claim 13, being further caused to determine the address of the gateway by at least one of the following:
retrieving the address from a memory of the user equipment;
retrieving the address from a domain name server;
retrieving the address from a signaling message received from the visited cellular network.

17. The user equipment of claim 13, further caused to:
determine a presence of a first condition that neither the home network is available nor a further network for which the roaming agreement exists between the home cellular network and the further cellular network and
determine a second condition that the visited network is supporting access for a user equipment for which no roaming agreement exists, wherein the access request is transmitted to the visited cellular network when it is determined that at least one of the first and second condition is presently fulfilled.

18. The user equipment of claim 17, further caused to determine the second condition based on a broadcast message received from the visited network, the broadcast message including a service identifier indicating that the visited cellular network is supporting a service providing access of not authenticated user equipment.

19. The user equipment of claim 13, further caused to select a radio cell of the visited cellular network for an access to the radio part of the visited cellular network based on a service identifier from the visited cellular network indicating that the visited cellular network is supporting access of mobile entities for which no roaming agreement is in place with the home cellular network of the user equipment.

20. The user equipment of claim 13, further caused, for establishing a connection to the gateway, to establish an authenticated and encrypted tunnel to the gateway.

21. The user equipment of claim 13, further caused to start a register procedure with the home cellular network, after a connection to the gateway has been established.

22.-31. (canceled)

32. A system comprising at least two entities from the following group of entities: a user equipment, an access management entity, and a session management entity;
the user equipment being configured to operate in in a visited cellular network for which no roaming agreement exists between a home cellular network of the user equipment and the visited cellular network, the user equipment comprising a memory and at least one processing unit, the memory comprising instructions executable by the at least one processing unit to cause the user equipment to:
transmit an access request to the visited cellular network requesting access to the visited cellular network, the access request comprising an identifier indicating to originate from a user equipment for which no roaming agreement exists with the home cellular network of the user equipment;
transmit a session establishment request to the visited network to establish a data packet session in the visited cellular network;
determine an address of a gateway providing access to the home cellular network; and
establish a connection to the gateway based on the determined address via the visited cellular network;
the access management entity comprising a memory and at least one processing unit, the memory comprising instructions executable by the at least one processing unit to cause the access management entity to:
receive a service request from a user equipment, connected to a visited cellular network, unknown to the visited cellular network, the service request comprising an identifier indicating to originate from a user equipment for which no roaming agreement exists with the home cellular network of the user equipment;
select, based on the received identifier, a session management entity configured to manage a data packet session for the user entity in the visited cellular network without a prior authentication of the user equipment or authorization for the user equipment; and
transmit a handling request to the selected session management entity to handle the data packet session for the user equipment; and
the session management entity comprising a memory and at least one processing unit, the memory comprising instructions executable by the at least one processing unit to cause the session management entity to:
receive a handling request from an access management entity of the visited cellular network to handle a data packet session for the user equipment, no roaming agreement existing between a home cellular network of the user equipment and the visited cellular network;
receive a session establishment request from the user equipment, the session establishment request comprising an identifier indicating to originate from a user equipment for which no roaming agreement exists with the home cellular network of the user equipment; and
set up the data packet session for the user equipment to an access point to be used by the user equipment for a connection to its home network without a prior authentication of the user equipment or authorization for the user equipment, based on the received identifier.

33.-37. (canceled)
